(19) United States
(12) Patent Application Publication
(10) Pub. No.: US 2004/0122739 A1
(43) Pub. Date: Jun. 24, 2004

(54) Material shortage simulation management system and method

(76) Inventor: Hung-Shan Wei, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/648,748

(22) Filed: Aug. 25, 2003

(30) Foreign Application Priority Data
Dec. 20, 2002 (TW) 91136955

(51) Int. Cl. G06G 1/14; G06F 17/60

(52) U.S. Cl. 705/22; 705/28

(57) ABSTRACT

A material shortage simulation management system (100) is for calculating quantities of material shortage relating to manufacturing orders (101). The system includes a database (200) for storing data used in procedures of material shortage simulations; a data obtaining unit (110) for obtaining data from the database; a computing unit (120) for calculating material requirement quantities and inventories, and for determining quantities of material shortage; a judging unit (130) for determining whether it is necessary to purchase material and adjust distributed inventories, and for ascertaining whether material shortage simulations of all materials in a manufacturing order have been finished; and a material adjustment unit (140) for allotting distributed inventories to current inventories when material shortages occur. A related method is also disclosed.

### BACKGROUND OF THE INVENTION

1. Field of the Invention

The present invention relates to a material requirements planning system and method for a manufacturer, and particularly to a material requirements planning system and method that deals with material shortages.

2. Background of the invention

With development of Material Requirements Planning (MRP), and popularization of computer technology and automated production, computer-aided systems and methods such as the just-in-time method have evolved in order to better handle material replenishment. However, material shortages in manufacturing processes still cannot be avoided completely. Accordingly, certain systems and methods for analyzing issues relating to material shortage have been developed. Such systems include the Manufacturing Order Management System developed by Zhenghang Information Ltd., the Manufacturing Order Management and Outsourcing System developed by Dingxing Computer Ltd., and the Management Information System for Small and Medium-sized Enterprises.

Although these systems provide methods for analyzing problems relating to material shortage, they do not adequately deal with means for solving problems relating to material shortage. Generally, when a material shortage occurs, it is necessary to replenish inventories. This can be achieved by adding a newly purchased quantity of the material, or by adjusting distributed inventories according to various requirement dates. A system and method for managing material shortages that successfully addresses the above-mentioned shortcomings and issues is desired.

### SUMMARY OF THE INVENTION

Accordingly, a main objective of the present invention is to provide a material shortage simulation management system and method which can readily calculate quantities of material shortage relating to manufacturing orders.

To achieve the above objective, a material shortage simulation management system in accordance with a preferred embodiment of the present invention is for calculating quantities of material shortage relating to manufacturing orders. The system comprises: a database for storing data used in procedures of material shortage simulations; a data obtaining unit for obtaining data from the database; a computing unit for calculating material requirement quantities and inventories, and for determining quantities of material shortage; a judging unit for determining whether it is necessary to purchase material and adjust distributed inventories, and for ascertaining whether material shortage simulations of all materials in a manufacturing order have been finished; and a material adjustment unit for allotting distributed inventories to current inventories when material shortages occur.

Further, the present invention provides a material shortage simulation management method for calculating quantities of material shortage relating to manufacturing orders. The method can be implemented using said material shortage simulation management system, and preferably comprises the steps of: obtaining a manufacturing order; reading data on a material from a bill of material (BOM) of the manufacturing order; calculating a shortage quantity of the material; determining whether it is necessary to purchase the material; determining whether it is necessary to adjust a related distributed inventory of the material, if it is not necessary to purchase the material; allotting the distributed inventory of the material if it is necessary to adjust the distributed inventory; determining whether material shortage simulations of all the materials in the manufacturing order have been finished; reading data on another material from the BOM if material shortage simulations of all materials have not been finished, and repeating above of the steps accordingly; and distributing the manufacturing order to corresponding work centers if and when material shortage simulations of all materials have been finished.

Other objects, advantages and novel features of the present invention will be drawn from the following detailed description with reference to the attached drawings, in which:

### BRIEF DESCRIPTION OF THE DRAWINGS

FIG. 1 is a schematic diagram of main documents used in a material shortage simulation management system in accordance with the preferred embodiment of the present invention;

FIG. 2 is a schematic diagram of logic units of the material shortage simulation management system of FIG. 1;

FIG. 3 is a flowchart of a preferred method for implementing the material shortage simulation management system of the present invention; and

FIG. 4 is a table showing main items of an exemplary material shortage statement in accordance with the present invention.

### DETAILED DESCRIPTION OF THE INVENTION

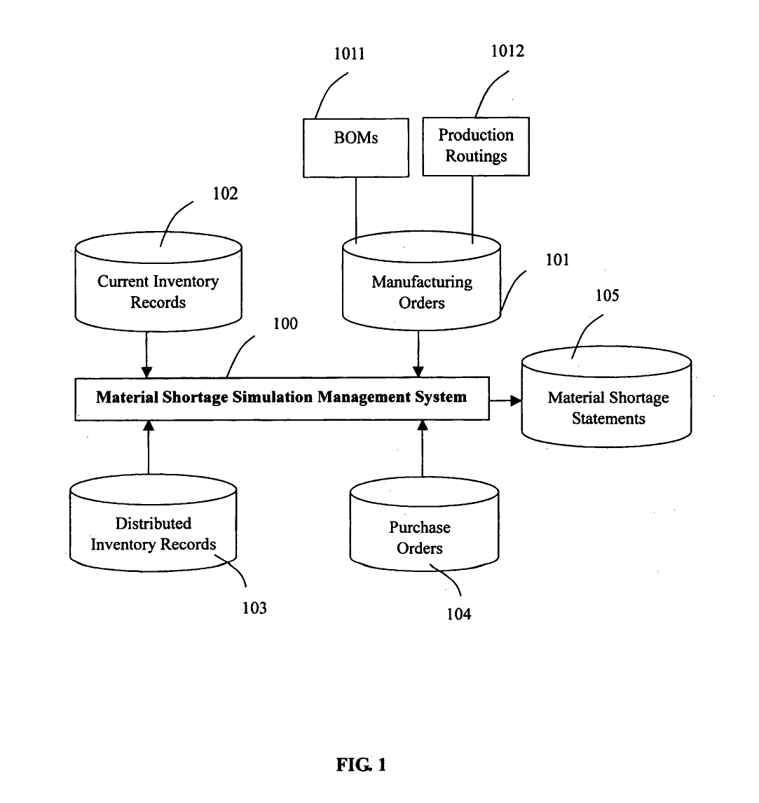

FIG. 1 is a schematic diagram of main documents used in a material shortage simulation management system 100 in accordance with the preferred embodiment of the present invention. The documents comprise manufacturing orders (MOs) 101, current inventory records 102, distributed inventory records 103, and purchase orders (POs) 104. Each manufacturing order 101 comprises a plurality of bills of material (BOMs) 1011, and production routings 1012. The material shortage simulation management system 100 can generate material shortage statements 105 by analyzing said documents.

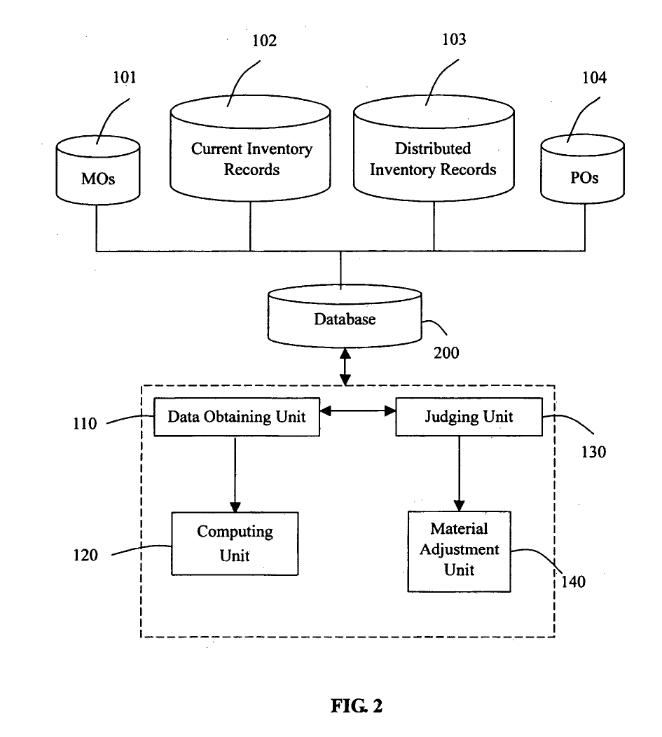

FIG. 2 is a schematic diagram of logic units of the material shortage simulation management system 100. The material shortage simulation management system 100 comprises a data obtaining unit 110, a computing unit 120, a judging unit 130, a material adjustment unit 140, and a database 200. The data obtaining unit 110 is for obtaining data stored in the database 200, said data comprising manufacturing orders 101, current inventory records 102, distributed inventory records 103 and purchase orders 104. Furthermore, the data obtaining unit 110 receives orders from users. The computing unit 120 is for calculating material requirement quantities and inventories, and determining quantities of material shortage. The judging unit 130 determines whether it is necessary to purchase a material and adjust distributed inventories, and ascertains whether material shortage simulations of all materials in a manufacturing order have been finished. The material adjustment unit 140 is for allotting distributed inventories to current inventories when material shortages occur.

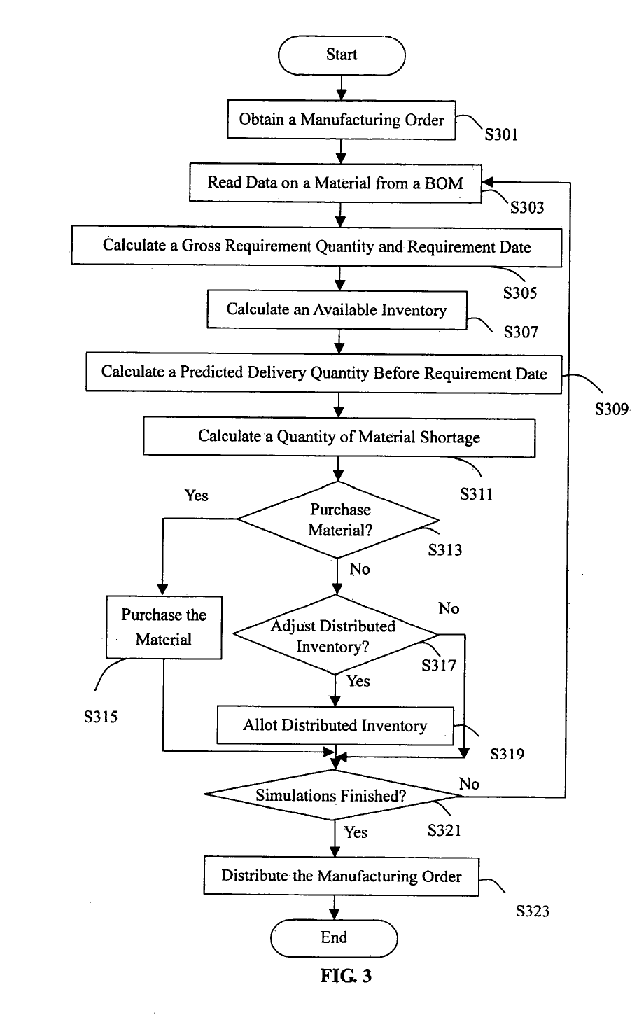

FIG. 3 is a flowchart of a preferred method for implementing the material shortage simulation management system 100 of the present invention. In step S301, the data obtaining unit 110 obtains a manufacturing order from the database 200. The manufacturing order generally comprises a plurality of material numbers, required quantities and required dates of various materials, BOMs, and production routings. In step S303, the data obtaining unit 110 reads data on a material from a BOM. In step S305, the computing unit 120 calculates a gross requirement quantity and a requirement date of the material according to the BOM and the related production routing. Material requirements for different manufacturing processes are shown in the BOM. The related production routing comprises information about which manufacturing processes need the material. In step S307, the computing unit 120 calculates an available inventory in accordance with the current inventory record 102 and the distributed inventory record 103 of the material. The available inventory is calculated by obtaining the current inventory in the current inventory record 102, and deducting the distributed inventory in the distributed inventory record 103. In step S309, the computing unit 120 calculates a predicted delivery quantity of the material before the requirement date according to the purchase orders 104 and the related production routing.

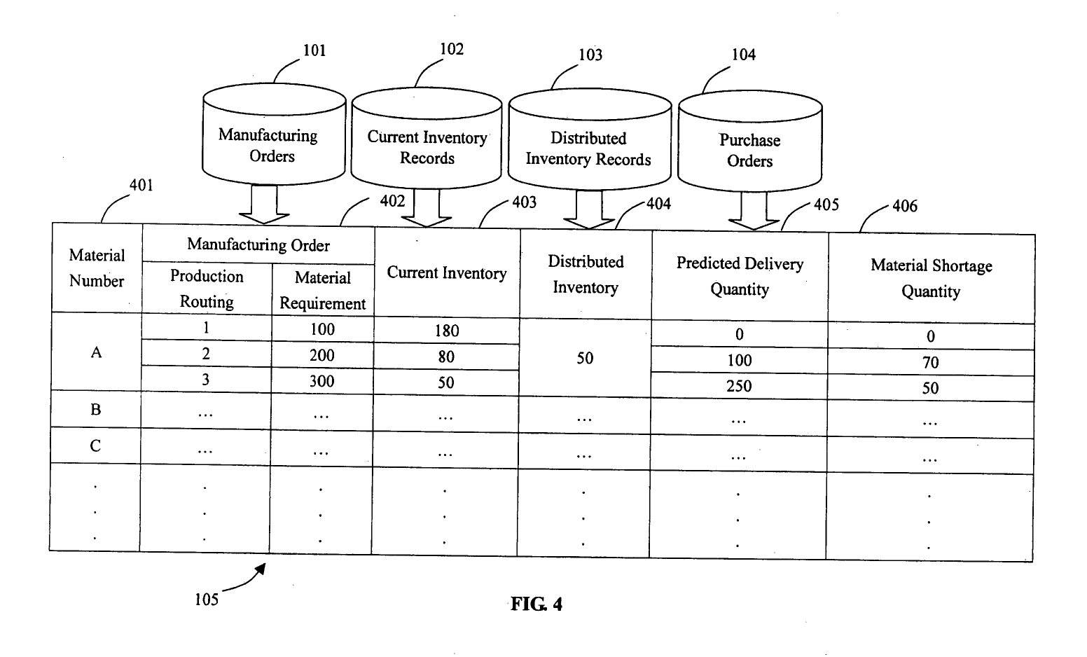

In step S311, the computing unit 120 calculates a quantity of material shortage by analyzing the gross requirement quantity and the gross inventory of the material. The shortage quantity of the material in the production routing can be calculated according to the material requirement, the available inventory and the predicted delivery quantity. By collecting information on material shortage quantities in various production routings, the computing unit 120 can generate a material shortage statement 105 (as shown in FIG. 4).

In step S313, the judging unit 130 determines whether it is necessary to purchase the material when a material shortage occurs. If it is necessary to purchase the material, in step 315, purchasing operators purchase the material, and the procedure proceeds to step S321 described below. If it is not necessary to purchase the material, in step S317, the judging unit 130 determines whether it is necessary to adjust the distributed inventory to replenish the current inventory. If there is no need to adjust the distributed inventory (i.e., the current inventory is sufficient), the procedure proceeds to step S321 described below. If there is a need to adjust the distributed inventory, in step S319, the material adjustment unit 140 allots the distributed inventory to the current inventory, and the procedure proceeds to step S321 described below. In step S321, the judging unit 130 checks whether material shortage simulations of all the materials in the manufacturing order have been finished. If material shortage simulations have not been finished, the procedure returns to step S303 in which the data obtaining unit 110 reads data on another material. If all material shortage simulations have been finished, in step S323, the manufacturing order can be distributed to corresponding work centers.

FIG. 4 is a table showing main items of an exemplary material shortage statement 105 in accordance with the present invention. Items in the material shortage statement 105 comprise a material number 401, a manufacturing order 402, a current inventory 403, a distributed inventory 404, a predicted delivery quantity 405, and a material shortage quantity 406. Further, each manufacturing order 402 comprises a production routing and a material requirement. Data in the blanks for the manufacturing order 402, the current inventory 403, the distributed inventory 404 and the predicted delivery quantity 405 can be obtained respectively from the manufacturing orders 101, the current inventory records 102, the distributed inventory records 103 and the purchase orders 104. Data in the blanks for the material shortage quantity 406 can be calculated by analyzing the material requirement, the current inventory 403, the distributed inventory 404 and the predicted delivery quantity 405.

An example of how to obtain the material shortage quantity is described below. As shown in FIG. 4, suppose that the current inventory of material A is 180, and its distributed inventory is 50. Thus the available inventory of material A is 130 (180 minus 50). Since the material requirement in production routing 1 is only 100, no material shortage occurs. In production routing 2, because production routing 1 requires 100 units of material A, the current inventory is 80 (180 minus 100). Taking into account the distributed inventory, the available inventory is 30 (80 minus 50). When the predicted delivery quantity is 100, the available inventory is 130 (30 plus 100). However, the material requirement in production routing 2 is 200, therefore the material shortage quantity is 70 (130 minus 200). The shortage quantity of material A can be replenished by adjusting the distributed inventory 404 or by purchasing material A. The material shortage quantities of other materials in various production routings can be obtained in the same way as described above.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A material shortage simulation management system for calculating quantities of material shortage relating to manufacturing orders, the system comprising:
a database for storing data used in procedures of material shortage simulations;
a data obtaining unit for obtaining data from the database;
a computing unit for calculating material requirement quantities and inventories, and for determining quantities of material shortage; and
a judging unit for determining whether it is necessary to purchase material and adjust distributed inventories, and for ascertaining whether material shortage simulations of all materials in a manufacturing order have been finished.

2. The material shortage simulation management system according to claim 1, further comprising a material adjustment unit for allotting distributed inventories to current inventories when material shortages occur.

3. The material shortage simulation management system according to claim 1, wherein the data stored in the database comprise manufacturing orders, current inventory records, distributed inventory records and purchase orders.

4. The material shortage simulation management system according to claim 3, wherein each of the manufacturing orders comprises a plurality of bills of material and production routings.

5. A material shortage simulation management method for calculating quantities of material shortage relating to manufacturing orders, the method comprising the steps of:
obtaining a manufacturing order;
reading data on a material from a bill of material (BOM) of the manufacturing order;
calculating a shortage quantity of the material;
determining whether it is necessary to purchase the material;
determining whether it is necessary to adjust a related distributed inventory of the material, if it is not necessary to purchase the material;
allotting the distributed inventory of the material if it is necessary to adjust the distributed inventory;
determining whether material shortage simulations of all materials in the manufacturing order have been finished;
reading data on another material from the BOM if material shortage simulations of all materials have not been finished, and repeating above of the steps accordingly; and
distributing the manufacturing order to one or more corresponding work centers if and when material shortage simulations of all materials have been finished.

6. The method according to claim 5, wherein the step of calculating a shortage quantity of the material comprises a step of calculating a gross requirement quantity and a requirement date of the material.

7. The method according to claim 5, wherein the step of calculating a shortage quantity of the material comprises a step of calculating an available inventory of the material.

8. The method according to claim 5, wherein the step of calculating a shortage quantity of the material comprises a step of calculating a predicted delivery quantity of the material before the requirement date.

9. A material shortage simulation management method for calculating quantities of material shortage relating to manufacturing orders, the method comprising steps of:
(a) obtaining a manufacturing order;
(b) checking material related to the order in inventory;
(c) calculating a shortage quantity of said material in inventory based upon a scheduled production plan of the order;
(d) if shortage, determining either purchasing the material or reallocating the material, which is currently designated to another manufacturing order, to the order; and
(e) repeating steps (b)-(d) until all materials related to the order have experienced material shortage simulation.
